(19) United States
(12) Patent Application Publication
(10) Pub. No.: US 2020/0340531 A1
(43) Pub. Date: Oct. 29, 2020

(54) CAGE FOR A ROLLER BEARING FOR ROTATIONALLY MOUNTING A HIGH-SPEED SHAFT

(71) Applicant: SCHAEFFLER TECHNOLOGIES AG & CO. KG, Herzogenaurach (DE)

(72) Inventors: Jerico ZIEGELHOEFER, Erlangen (DE); Horst HUPPMANN, Baiersdorf (DE); Benedikt SCHREIBER, Erlangen (DE); Steffen SAEBSCH, Weisendorf (DE)

(73) Assignee: Schaeffler Technologies AG & Co. KG, Herzogenaurach (DE)

(21) Appl. No.: 16/092,226

(22) PCT Filed: Apr. 11, 2017
(86) PCT No.: PCT/DE2017/100291

§ 371 Date: Oct. 9, 2018

(30) Foreign Application Priority Data
Apr. 20, 2016 (DE) 10 2016 206 697.8

(51) Int. Cl. F16C 33/38; B21D 53/12

(52) U.S. Cl. CPC F16C 33/3887; B21D 53/12

(57) ABSTRACT

A roller bearing for rotationally mounting a high-speed shaft, such as a shaft for a turbocharger, includes a cage. The cage has two rings and a plurality of connecting elements and cavities for the rolling bodies. The connecting elements extend axially between the cage rings, and the cavities are located between the connecting elements. The cage is made from a metallic material and is formed according to a shaping method, wherein two tangentially adjacent ends of the cage are interconnected in a material fit.

### CROSS-REFERENCE TO RELATED APPLICATIONS

This application is the U.S. National Phase of PCT/DE2017/100291 filed Apr. 11, 2017, which claims priority to DE 102016206697.8 filed Apr. 20, 2016, the entire disclosures of which are incorporated by reference herein.

### TECHNICAL FIELD

The disclosure relates to a cage for a roller bearing for rotationally mounting a high-speed shaft. The disclosure also relates to a roller bearing with the aforementioned cage. In particular, the cage is provided to be used in a roller bearing of a turbocharger. A high-speed shaft involves a shaft that has at least a speed of 30,000 revolutions per minute. In particular, a high-speed shaft involves a spindle shaft or a rotor shaft of a turbocharger.

### BACKGROUND

Roller bearings comprise rolling bodies, as well as an outer ring and, if necessary, an inner ring, on each of which a roller track is formed. The rolling bodies roll between the outer and inner rings on the roller tracks and are spaced apart by means of a cage with rolling body cavities distributed over its circumference. The cage can be guided on the rolling bodies or on one of the rings, wherein in turbochargers the cage is usually guided on the outer ring, but it can also be guided on the inner ring. The special operating conditions of a turbocharger pose special challenges on the design of the bearings. The rotor shaft rotates at a speed which, due to its absolute height and its fluctuations, transfers high loads into the bearing. Turbochargers are operated at a constantly changing speed, which can reach up to 300,000 revolutions per minute at peak times. In addition, high operating temperatures of up to 400° C. prevail, especially near the turbine wheel, which affect the lubricant and the materials used.

DE 10 2014 213 256 B3 discloses a double row angular contact ball bearing of a turbocharger comprising an angular contact ball bearing with an outer ring and a cage. Rolling body cavities are arranged along the circumference of the cage. Furthermore, along only one end of the outer ring, a cage guide surface is extending, which forms a pair of sliding surfaces with a surface on the inner circumference of the outer ring. The contour of the cage is produced by means of a cutting process, for example by rotation. In this way, a wide range of different contours can be implemented, to avoid unnecessary wear and tear.

It is one objective of the present disclosure to further develop a cage for a roller bearing for rotatably supporting a high-speed shaft, in particular by reducing the production costs of the cage and shortening the production time of the cage.

### SUMMARY

An inventive cage for a roller bearing for rotatably supporting a high-speed shaft, in particular a shaft for a turbocharger, comprises two cage rings and a plurality of connecting elements and cavities for rolling bodies, the connecting elements extending axially between the cage rings, and the cavities being arranged tangentially (or circumferentially) between the connecting elements. Furthermore, the cage consists of a metal material and is essentially configured by using metal forming technology, two tangentially adjacent ends of the cage being joined together. Thus, the cage is configured in the form of a weld-bending cage. The cage is made of profiled material by forming, in particular by rolling, the cavities being produced by punching. In particular, it is possible to produce different profiles of a cage cross section. It is also possible to use different rolling bodies, in particular balls, needles or rollers. Furthermore, the cavities can be punched out as required, wherein the contact surface between the rolling body and the cage can be embossed, which results in strain hardening. Preferably, the connecting elements can be configured in asymmetric manner. Finally, tangentially adjacent ends of the cage are joined by welding, thus forming the ring-shaped cage. A possible imbalance caused by the welding seam can be compensated by a specific adjustment of the formation of the cavities.

In an embodiment, the respective connecting element has at least one contact surface for guiding the respective rolling body of the roller bearing. In particular, the respective connecting element has multiple contact surfaces for guiding the respective rolling body. In particular, the respective contact surface is configured in the form of a tangential embossing.

In an embodiment, an outer circumferential surface of the cage is partially attached with an outer ring of the roller bearing. Together with the outer ring of the roller bearing, the outer circumference of the cage forms a sliding surface, which is used to guide the cage.

Alternatively, or in addition, an inner circumferential surface of the cage is attached at least partially with an inner ring of the roller bearing. If, in addition to the outer circumferential surface of the cage, the inner circumferential surface of the cage is attached at least partially with a respective ring of the roller bearing, the stability of the cage is increased, but this also increases the frictional forces. However, it is also possible that the cage is attached neither with the inner ring nor with the outer ring of the cage but is guided only by the rolling body.

In an embodiment, a friction-minimizing and/or corrosion-resistant coating is at least partially formed on the surface of the cage. Preferably, the coating is configured as a silver coating, CVD or PVD coating. In particular, the silver coating is configured for dry-running properties when the cage starts on the respective ring. In particular, the friction-minimizing coating is only formed on the contact surfaces of the cage in relation to the respective ring of the roller bearing.

The disclosure includes the technical teaching that heat treatment is provided to adjust the structure and/or hardness of the cage. Advantageously, the cage is nitrocarburized or case-hardened. In particular, the cage is made of a weldable metal material, for example, C 15 or DC 03.

### BRIEF DESCRIPTION OF THE DRAWINGS

Subsequently, further description is provided in more detail together with the description of embodiments, using the figures in which identical or similar elements are provided with the same reference numerals. It is shown

FIG. 1 shows a simplified schematic sectional view to illustrate the construction of an inventive roller bearing,

FIG. 2 shows a schematic perspective to illustrate the structure of an inventive cage according to FIG. 1,

FIG. 3 shows a schematic sectional view of the inventive cage according to a second embodiment,

FIG. 4 shows a schematic sectional view of the inventive cage according to a third embodiment,

FIG. 5 shows a schematic sectional view of the inventive cage according to a fourth embodiment, and

FIG. 6 shows a schematic sectional view of the inventive cage according to a fifth embodiment.

### DETAILED DESCRIPTION OF THE DRAWINGS

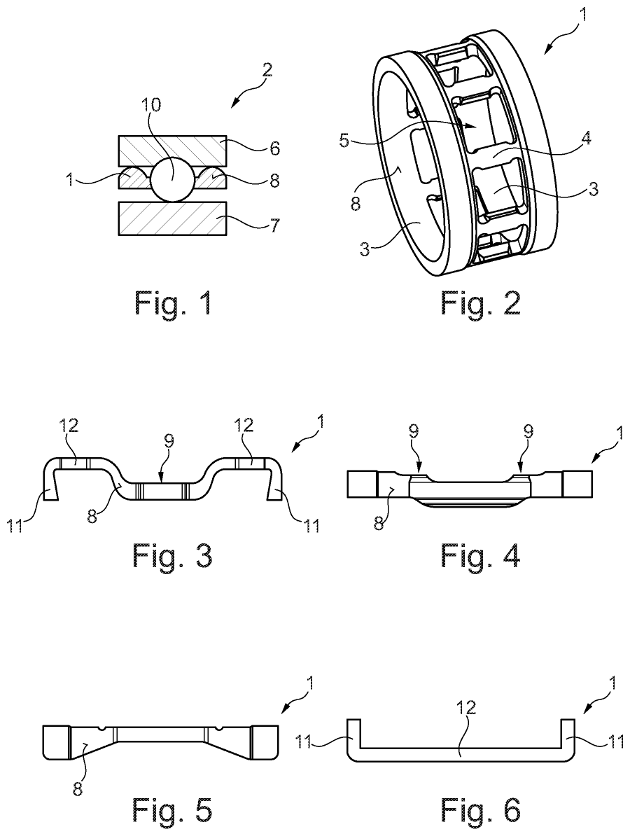

According to FIG. 1, an inventive roller bearing 2 for rotationally mounting a high-speed shaft (not shown) comprises an outer ring 6 and an inner ring 7, as well as a row of rolling bodies 10 arranged radially between the outer ring 6 and the inner ring 7. The roller bearing 2 is configured to rotatably support the shaft of a turbocharger. Furthermore, the roller bearing 2 comprises a cage 1, which is provided to guide the rolling bodies.

An outer circumferential surface of the cage 1 is partially attached with the outer ring 6 of roller bearing 2. The outer circumferential surface of the cage 1 is partially configured in spherical fashion to minimize a contact surface between the outer ring 6 and the cage 1.

FIG. 2 shows the cage depicted in FIG. 1. According to FIG. 2, the cage 1 comprises two cage rings 3, as well as a plurality of connecting elements 4 and cavities 5 for the rolling body 10 depicted in FIG. 1. The connecting elements 4 extend axially between the cage rings 3, wherein the cavities are arranged in tangential fashion between the connecting elements 4, each receiving a respective rolling body 10. Furthermore, the cage 1 consists of a weldable, metal material and is essentially configured by using forming technology, whereby two tangentially adjacent ends of cage 1 are materially joined together. In other words, the cage has a ring-shaped and one-part configuration.

FIG. 3 shows a second embodiment of the inventive cage 1. The cage shown in FIG. 3 essentially has an M-shaped configuration and comprises two legs 11, which essentially extend in radial fashion and are attached with the inner ring (shown in FIG. 1) to support the cage 1 also on the inner ring 7. Furthermore, the cage 1 with two essentially axial sections 12 is attached with the outer ring 6 (shown in FIG. 1). In contrast to the embodiment of the cage 1 shown in FIGS. 1 and 2, the outer circumferential surface of the cage 1 is not configured in spherical fashion, but in cylindrical fashion. A contact surface 9 connected axially between the two axially extending sections 12 is used to guide the respective rolling body 10. The contact surface 9 can be radially displaced in the forming process of cage 1 to be adapted to the respective rolling bodies 10.

FIG. 4 shows a third embodiment of the inventive cage 1. The cage 1 shown in FIG. 4 essentially has a V-shaped configuration and comprises two contact surfaces 9, which are provided to guide the respective rolling body 10. Furthermore, the outer circumferential surface of cage 1 is provided to be attached with the outer ring 6 of roller bearing 2.

FIG. 5 shows a fourth embodiment of the inventive cage 1. The cage shown in FIG. 5 essentially has an A-shaped configuration and is provided to be attached with the outer circumferential surface on the outer ring 6 of the roller bearing 2 and to be attached with the inner circumferential surface partially on the inner ring 7 of the roller bearing 2.

FIG. 6 shows a fifth embodiment of the inventive cage 1. The cage 1 shown in FIG. 5 essentially has a U-shaped configuration and is provided to be guided through rolling bodies 10, wherein the U-shaped cage 1 is attached neither with the outer ring 6 nor with the inner ring 7. The U-shaped cage 1 has two legs 11 bent to the outside and an axially extending section 12 formed between them.

All five embodiments of the inventive cage 1 were subjected to heat treatment to adjust the structure and hardness of cage 1. Furthermore, all five embodiments of the inventive cage 1 also show a friction-minimizing and corrosion-resistant coating 8 on the entire surface.

### REFERENCE NUMERALS

1 cage
2 Roller bearing
3 cage rings
4 connecting element
5 cavity
6 outer ring
7 inner ring
8 coating
9 contact surface
10 rolling body
11 leg
12 axially extending section

1. A cage for a roller bearing for rotationally supporting a high-speed shaft, comprising:
two cage rings;
a plurality of connecting elements extending axially between the cage rings and connecting the cage rings, the connecting elements and cage rings cooperating to define a plurality of cavities for the rolling bodies, wherein the cavities are arranged tangentially between the connecting elements, and wherein the cage comprises a weldable metal material and is configured by using forming technology in which two tangentially adjacent ends of the cage are welded together.

2. A cage according to claim 1, wherein the cavities are produced by punching and embossing.

3. A cage according to claim 1, wherein an outer circumferential surface of the cage is attached at least partially with an outer ring of the roller bearing.

4. A cage according to claim 3, wherein the outer circumferential surface of the cage is partially configured in spherical fashion to minimize a contact surface between the outer ring and the cage.

5. A cage according to claim 1, wherein an inner circumferential surface of the cage is attached at least partially with an inner ring of the roller bearing.

6. A cage according to claim 1, wherein a friction-minimizing and corrosion-resistant coating is at least partially formed on the surface of the cage.

7. A cage according to claim 1, wherein heat treatment is provided to adjust the structure and hardness of the cage.

8. A cage according to claim 1, wherein each connecting element has at least one contact surface for guiding a respective one of the rolling bodies of the roller bearing.

9. Use of a cage according to claim 1 in a roller bearing of a turbocharger.

10. (canceled)

11. A roller bearing comprising:
an inner ring extending about an axis;
an outer ring extending about the axis;
a plurality of rolling bodies arranged about the axis and radially between the inner ring and outer ring; and
a one-piece cage having a first cage ring axially spaced from a second cage ring, the cage further including a plurality of connecting elements extending axially between and connecting the first and second cage rings and interposed by cavities circumferentially therebetween, wherein two circumferentially adjacent ends of the cage are welded together, and wherein each rolling body is disposed circumferentially between two adjacent connecting elements.

12. The roller bearing of claim 11, wherein each cage ring has an outer circumferential surface that contacts the outer ring.

13. The roller bearing of claim 12, wherein each outer circumferential surface of the cage rings has a spherical profile to minimize contact between the cage and the outer ring.

14. The roller bearing of claim 11, wherein each cage ring has an inner circumferential surface that contacts the inner ring.

15. The roller bearing of claim 11, wherein the roller bearing is part of a turbocharger.
